(19) United States
(12) Patent Application Publication
(10) Pub. No.: US 2013/0062204 A1
(43) Pub. Date: Mar. 14, 2013

(54) REDUCING ELASTO-CAPILLARY COALESCENCE OF NANOSTRUCTURES WITH APPLIED ELECTRICAL FIELDS

(71) Applicants: Kirk Jeremy Ziegler, Gainesville, FL (US); Justin Joseph Hill, Merritt Island, FL (US)

(72) Inventors: Kirk Jeremy Ziegler, Gainesville, FL (US); Justin Joseph Hill, Merritt Island, FL (US)

(21) Appl. No.: 13/637,468

(22) PCT Filed: Mar. 30, 2011
(86) PCT No.: PCT/US11/30438

§ 371 Date: Sep. 26, 2012

Related U.S. Application Data
(60) Provisional application No. 61/319,025, filed on Mar. 30, 2010.

(51) Int. Cl. B03C 7/00; F26B 1/00

(52) U.S. Cl. CPC B03C 7/00; F26B 1/00
USPC 204/450; 204/600; 356/319

(57) ABSTRACT

Various methods and systems are provided for reducing elasto-capillary coalescence of nanostructures. In one embodiment, a method includes providing a plurality of wet nanostructures on an electrode with a counter electrode positioned in air opposite the wet nanostructures. An electric field is applied between the counter electrode and the wet nanostructures using a voltage source, thereby reducing aggregation of the nanostructures. In another embodiment, an elasto-capillary coalescence reduction apparatus includes an electrode configured to receive a plurality of wet nanostructures, a counter electrode positioned in air opposite the wet nanostructures, and a voltage source coupled to the electrode and the counter electrode. The voltage source is configured to apply an electric field across the electrode and the nanostructures, which causes each of the nanostructures to repel a neighboring nanostructure.

### CROSS REFERENCE TO RELATED APPLICATIONS

This application claims priority to copending U.S. provisional application entitled “REDUCING ELASTO-CAPILLARY COALESCENCE OF NANOSTRUCTURES WITH APPLIED ELECTRICAL FIELDS” having Ser. No. 61/319,025, filed Mar. 30, 2010, the entirety of which is hereby incorporated by reference.

### BACKGROUND

Elasto-capillary coalescence of high aspect ratio structures is a phenomenon that has long existed in nature and artificial systems. Surface tension can induce forces on wetted nanostructures, such as vertically oriented nanowire arrays, that can force the nanostructures to aggregate when dried. This aggregation can result in decreased homogeneity and surface area of the array, which often inhibits the intended application.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1-5 are graphical representations of examples of elasto-capillary coalescence reduction apparatus in accordance with various embodiments of the present disclosure.

FIG. 6 is a non-limiting diagram illustrating forces acting upon nanostructures in the presence of an electric field in the elasto-capillary coalescence reduction apparatus of FIGS. 1-5 in accordance with various embodiments of the present disclosure.

FIG. 7 is a conceptual graph illustrating forces acting on the nanostructures of FIG. 6 with respect to nanostructure length in accordance with various embodiments of the present disclosure.

FIG. 8 is a flow chart illustrating the reduction of elasto-capillary coalescence from a plurality of nanostructures of FIGS. 1-5 in accordance with various embodiments of the present disclosure.

FIG. 9 is a flow chart illustrating the creation of a plurality of nanostructures of FIGS. 1-5 in accordance with various embodiments of the present disclosure.

FIG. 10 is a flow chart illustrating the measurement of elasto-capillary coalescence of a plurality of nanostructures of FIGS. 1-5 in accordance with various embodiments of the present disclosure.

FIG. 11 is a graph illustrating the change in light transmission through a plurality of nanostructures of FIGS. 1-5 in accordance with various embodiments of the present disclosure.

### DETAILED DESCRIPTION

Disclosed herein are various embodiments of methods related to reducing elasto-capillary coalescence of nanostructures. Reference will now be made in detail to the description of the embodiments as illustrated in the drawings, wherein like reference numbers indicate like parts throughout the several views.

Elasto-capillary coalescence refers to the aggregation of wetted nanostructures as the nanostructures dry. Elasto-capillary coalescence can decrease the homogeneity, surface area, and functionality of nanostructures. The various embodiments described herein concern applying electrical fields to the wetted nanostructures to cause them to repel each other in order to prevent the nanostructures from aggregating as they dry. Specifically, the aggregation forces are reduced by introducing small electric fields during drying, resulting in a technique that is applicable to a broad range of nanostructure materials, cross-sectional areas, lengths, and spacing.

For instance, when nanowires, which are an example of high aspect ratio nanostructures, are formed in porous templates, such as anodic aluminum oxide (AAO) or self-assembled block copolymers, the template must be removed with a liquid etchant to obtain a freestanding array of wet nanowires. When the array is dense and the nanowires have a high aspect ratio, the surface tension between the residual fluid film and nanowires leads to aggregation as the wet nanowires dry. However, by introducing small electric fields during drying, as will be discussed below, the elasto-capillary coalescence of the nanowires can be reduced or eliminated.

The dynamics of aggregation for nanostructures induced by surface tension is quite complex. Aggregation involves many factors, including the periodicity, dimensions, separation distance, and tensile strength of the material(s) of the nanostructures, as well as the evaporation rate and the surface tension of the fluid. The tendency for the nanostructures to aggregate during drying is only sufficiently reduced in the cases where no fluid-solid meniscus is present, fluids with zero surface tension, or the case where the nanostructure is stiff enough to overcome aggregation forces. Currently, supercritical fluid drying (near zero surface tension fluid) can inhibit the aggregation of nanostructures by surface tension. Even though drying nanostructures in supercritical fluids is an effective way to prevent aggregation, the process relies on high-pressure vessels, is restricted to batch-type processes with limited throughput, and is energy-intensive.

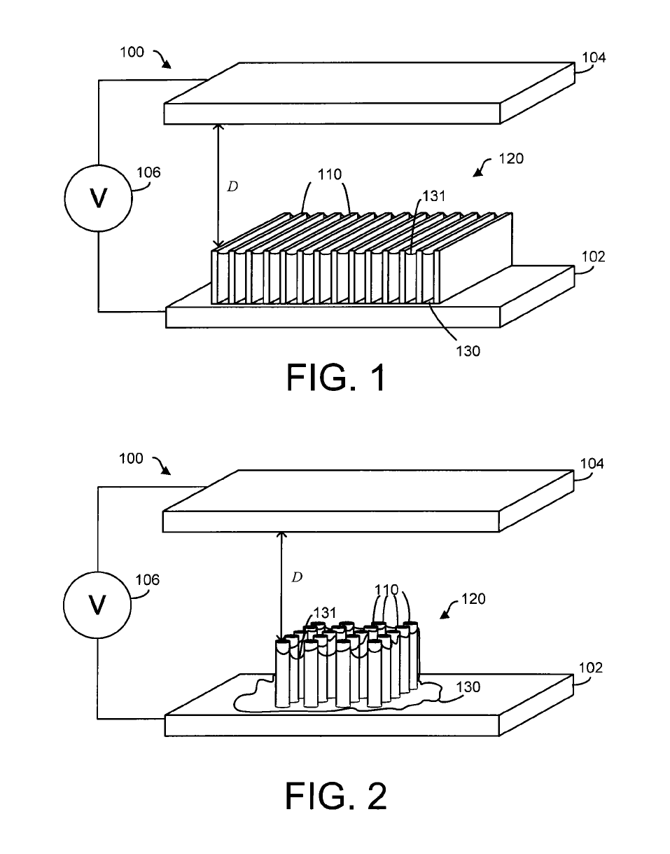

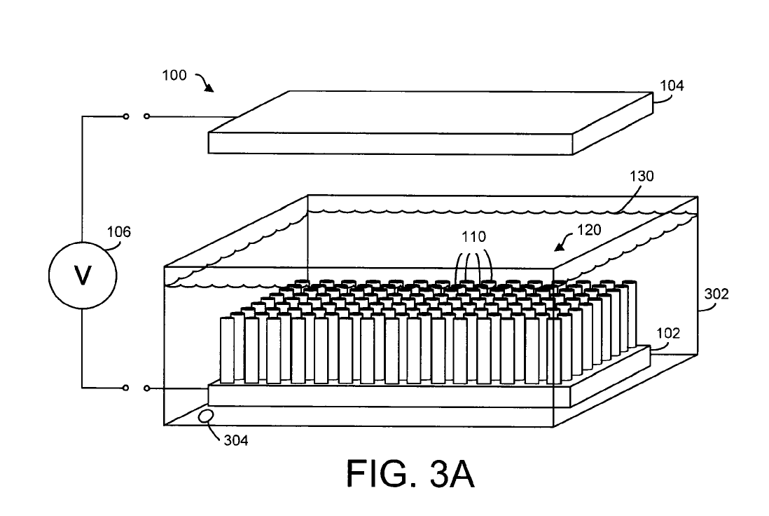

With reference to FIGS. 1 and 2, shown are diagrams illustrating a non-limiting embodiment of an elasto-capillary coalescence reduction apparatus 100. The elasto-capillary coalescence reduction apparatus 100 includes an electrode 102 and a counter electrode 104 biased by a voltage source 106 coupled to the electrode 102 and the counter electrode 104.

A plurality of nanostructures 110, forming an array 120, may be fabricated directly onto or positioned onto the electrode 102. The nanostructures 110 are wetted by a fluid 130 to prevent elasto-capillary coalescence. The nanostructures 110 are wet to the extent that a meniscus 131 is present in the fluid 130 between a nanostructure 110 and a neighboring nanostructure 110. In some embodiments, the nanostructures 110 are wet to the extent that the meniscus 131 is located near the top of the nanostructure 110 and neighboring nanostructure 110. The nanostructures 110 may include thin fin structures, micro-electro mechanical systems (MEMS), nanopillars, nanowires, and/or other nanostructures. In the embodiment illustrated in FIG. 1, the nanostructures 110 include thin fin structures, and in the embodiment illustrated in FIG. 2, the nanostructures 110 include nanowires.

The counter electrode 104 is positioned at a working distance D opposite the nanostructures 110 on the electrode 102. The electrode 102 and counter electrode 104 are each sized and dimensioned to provide an electrical field between the counter electrode and nanostructures 110. The fluid 130 wetting the nanostructures 110 dries so that air is the medium that separates nanostructures 110 and counter electrode 104. Before any elasto-capillary coalescence of the nanostructures 110 occurs, a voltage is applied by the voltage source 106.

The electrode 102 and/or the counter electrode 104 may be constructed of a conductive material. In some embodiments, the electrode 102 and/or the counter electrode 104 includes a transparent conductive material such as a tin-doped indium oxide (ITO) or fluorine-doped tin oxide (FTO) substrate. In other embodiments, the electrode 102 and/or the counter electrode 104 may be constructed of materials such as Pt, Pd, Ag, Au, Cu, C, Si, Ge, Ti, Cr, another conductive material, and/or alloys thereof.

The nanostructures 110 may be composed of any material as long as sufficient electric field induced surface charging will occur. In some embodiments, the nanostructures 110 are composed of metallic compounds, such as Au, Ag, Ni, Pt, Pd, C, Cu, and/or another metallic compound. In other embodiments, the nanostructures 110 are composed of semiconducting materials, including Group IV semiconductors, such as Si, Ge, Group III/V semiconductors, such as GaAs, InAs, GaN, and InP, Group II/VI semiconductors, such as CdSe, ZnS, and CdTe, and Group IV/VI semiconductors, such as PbSe, PbTe, and SnTe. In other embodiments, the nanostructures 110 are composed of oxides, such as TiO₂, SiO₂, Al₂O₃, Nb₂O₅, HfO₂, MgO, Y₂O₃, ZrO₂, ZnO, and SnO₂. In other embodiments, the nanostructures 110 are composed of polymers, such as polythiophene, polyacetylene, polypyrrole, polyaniline, and polyphenylene sulfide. In some embodiments, the nanostructures 110 are compound nanostructures including one or more sub-structures and/or one or more material(s). For example, referring to the embodiment illustrated in FIGS. 1 and 2, each nanostructure 110 may include different materials. These sub-structures may include different materials.

In some embodiments, the nanostructures 110 have been made wet by a fluid 130 such as de-ionized water. In other embodiments, the nanostructures 110 have been made wet by other fluids 130 such as organic solvents, salt solutions, or acids.

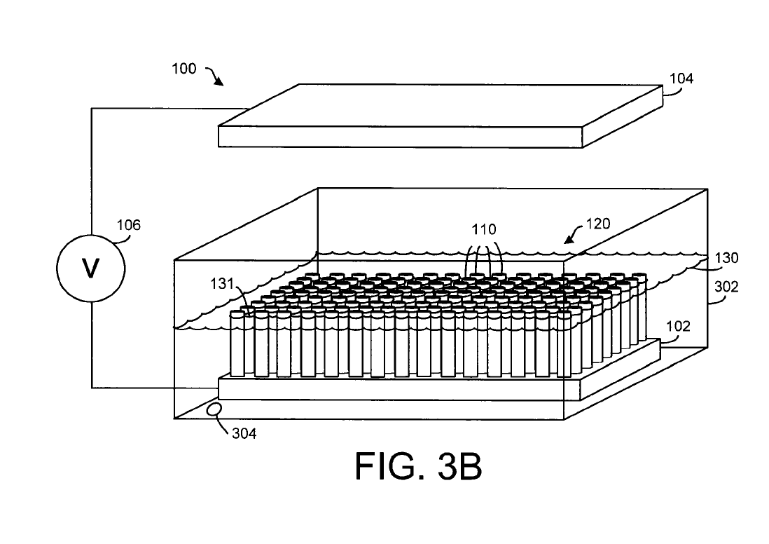

Referring next to FIGS. 3A and 3B, shown are diagrams illustrating another non-limiting embodiment of an elasto-capillary coalescence reduction apparatus 100. The embodiment illustrated in FIG. 3A is similar to the embodiment illustrated in FIGS. 1 and 2. In FIG. 3A, however, the electrode 102 is positioned in a vessel 302 configured to house the electrode 102 and receive at least a portion of each of the nanostructures 110. Also, the vessel 302 is further configured to receive a fluid 130, and in the embodiment illustrated in FIG. 3A, the vessel 302 contains the fluid 130. Also, the vessel 302 includes a drain hole 304 for draining the fluid 130 from the vessel 302. The nanostructures 110 are immersed in the fluid 130 in the embodiment illustrated in FIG. 3A to prevent premature aggregation, whereas the nanostructures 110 illustrated in FIGS. 1 and 2 are merely wet. Also, a voltage is not applied to the electrodes 102 and 104 while the nanostructures 110 are immersed in the fluid 130.

FIG. 3B is a diagram illustrating the embodiment of the elasto-capillary coalescence reduction apparatus 100 shown in FIG. 3A having a voltage applied by the voltage source 106 as the fluid 130 is drained from the vessel 302. Similar to the embodiment illustrated in FIGS. 1 and 2, the nanostructures 110 are wet to the extent that a meniscus 131 is present in the fluid 130 between a nanostructure 110 and a neighboring nanostructure 110, although the fluid 130 is at a higher level in FIG. 3B. The voltage source 106 applies a voltage to the electrodes 102 and 104 to apply an electric field between the counter electrode 104 and the wet nanostructures 110 as the nanostructures 110 dry.

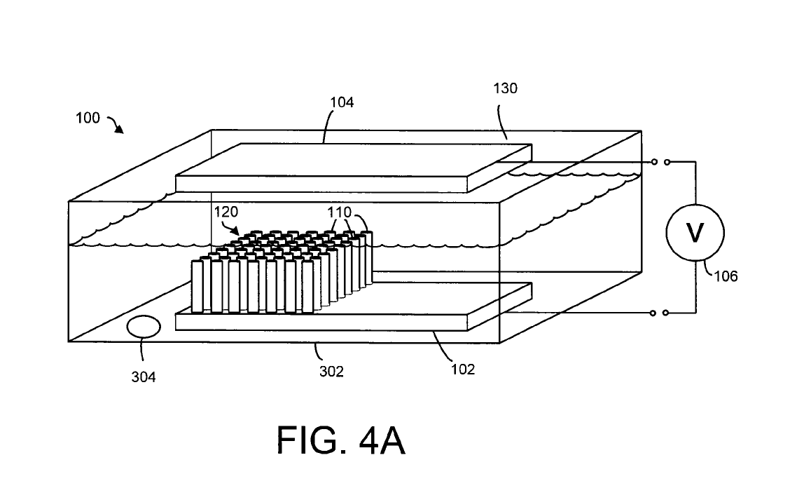

Referring now to FIGS. 4A and 4B, shown are diagrams illustrating a further non-limiting embodiment of an elasto-capillary coalescence reduction apparatus 100. The embodiment illustrated in FIG. 4A is similar to the embodiment illustrated in FIG. 3A. However, in FIG. 4A, both the electrode 102 and the counter electrode 104 are positioned in a vessel 302. The vessel 302 is configured to house the electrode 102 and the counter electrode 104 as well as receive at least a portion of each of the nanostructures 110. Also, the vessel 302 is further configured to receive a fluid 130. In the embodiment illustrated in FIG. 4A, the vessel 302 contains the fluid 130. Accordingly, similar to FIG. 3A, at least a portion of each of the nanostructures 110 is immersed in the fluid 130 in the embodiment illustrated in FIG. 4A.

FIG. 4B is a diagram illustrating the embodiment of the elasto-capillary coalescence reduction apparatus 100 shown in FIG. 4A having a voltage applied by the voltage source 106 as the fluid 130 is drained from the vessel 302. Similar to the embodiment illustrated in FIGS. 1 and 2, the nanostructures 110 are wet to the extent that a meniscus 131 is present in the fluid 130 between a nanostructure 110 and a neighboring nanostructure 110, although the fluid 130 is at a higher level in FIG. 4B. The voltage source 106 applies a voltage to the electrodes 102 and 104 to apply an electric field between the counter electrode 104 and the wet nanostructures 110 as the nanostructures 110 dry.

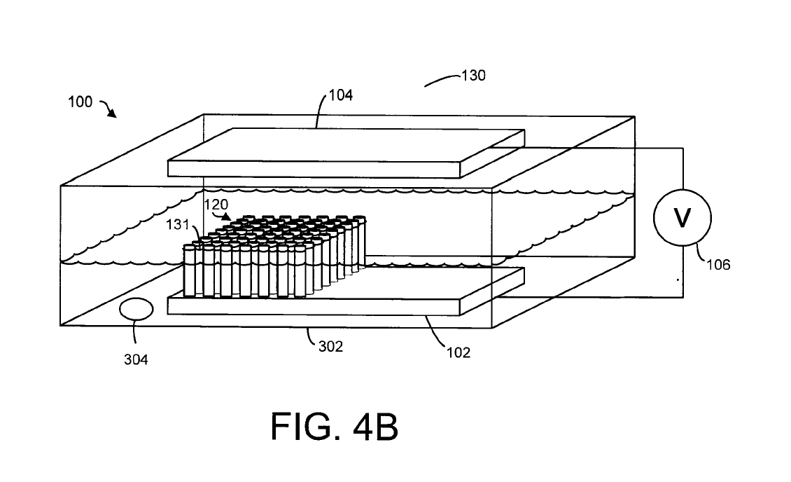

Referring next to FIGS. 5A and 5B, shown are diagrams illustrating still another non-limiting embodiment of an elasto-capillary coalescence reduction apparatus 100. The embodiment illustrated in FIG. 5A is similar to the embodiment illustrated in FIG. 4A, except that the elasto-capillary coalescence reduction apparatus 100 illustrated in FIG. 5A includes a light source 540 and a spectrophotometer 550. The vessel 302 and electrodes 102 and 104 are made of transparent material(s). For example, the vessel 302 may include glass, and one or more of the electrodes 102 and 104 may include an ITO film. In the embodiment illustrated in FIG. 5A, the vessel 302 is mounted on a rotational stage 560 to adjust the position of the vessel 302 with respect to the light source 540.

FIG. 5B is a diagram illustrating the embodiment of the elasto-capillary coalescence reduction apparatus 100 shown in FIG. 5A having a voltage applied by the voltage source 106 as the fluid 130 is drained from the vessel 302. Similar to the embodiment illustrated in FIGS. 1 and 2, the nanostructures 110 are wet to the extent that a meniscus 131 is present in the fluid 130 between a nanostructure 110 and a neighboring nanostructure 110, although the fluid 130 is at a higher level in FIG. 5B.

The light source 540 transmits light through the electrode 102 and illuminates the nanostructures 110. The vessel 302 is oriented using the rotational stage 560 such that the incident light 542 is parallel to the orientation of the nanostructures 110 to maximize initial light transmittance. The light interacting with the nanostructures 110 is either transmitted, scattered, reflected, or absorbed by the material(s) of the nanostructures 110, the electrodes 102 and 104, the material of the vessel 302, and/or the fluid 130. At least a portion of the light that passes through the nanostructures 110 also passes through the counter electrode 104. The light 544 is then received by a spectrophotometer 550 that performs a spectral analysis on the received light 544. In some embodiments, the spectrophotometer 550 includes the light source 540 and/or is configured to receive the vessel 302 as well. The degree of aggregation can be quantified by monitoring the relative decrease of light transmitted through the nanostructure array 120.

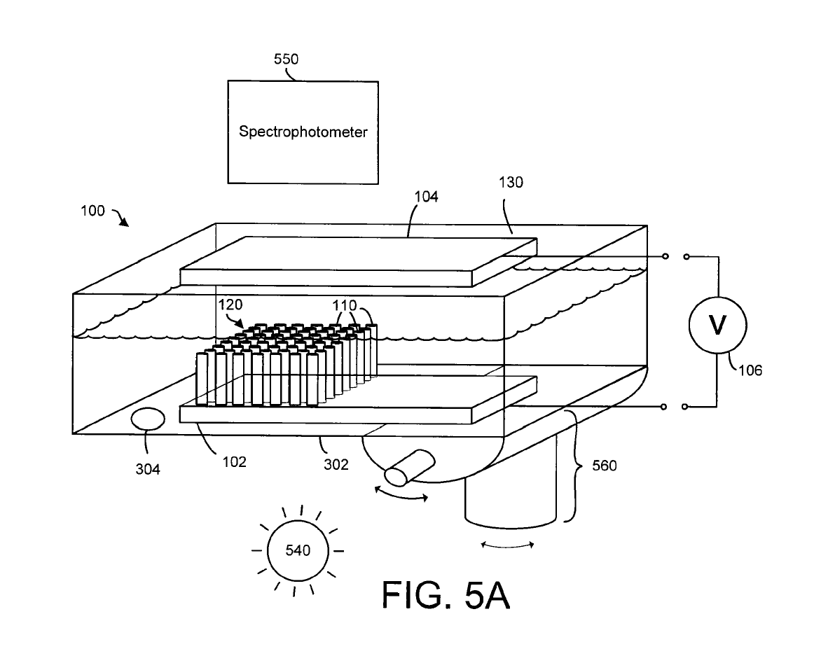

Referring to FIG. 6, shown is a non-limiting diagram illustrating the forces acting upon a pair of nanostructures 110a and 110b in the presence of an electric field. The aggregation of nanostructures 110 due to surface tension arises from perturbations in the drying process and inhomogeneities in nanostructure 110 size and sparing. Depending on the contact angle θ of the meniscus 131 between two nanostructures 110, either a repulsive or an attractive force can be exerted between the two nanostructures 110. If this force overwhelms the stiffness of one of the nanostructures 110, then that nanostructure 110 will bend towards the other nanostructure 110. This bending force can plastically deform the nanostructures 110 if the force is greater than the tensile strength of the material or push the nanostructures 110 close enough that surface energies or short range van der Waals interactions keep the nanostructures 110 in contact.

Neglecting the short-range van der Waals attractive forces between the nanostructures 110a and 110b, a force balance is depicted in FIG. 6 that describes the relation between the opposing forces from surface tension, Fₛₜ, the elastic bending force of the nanostructures 110a, Fₑₗₐₛ, and any electrostatic repulsion Fₑₛᵣ, from charge buildup on the nanostructures 110a and 110b:

ΣF=Fₛₜ−Fₑₗₐₛ−Fₑₛᵣ EQN (1)

If the sum of the forces is positive, then the nanostructure 110a bends until the forces balance, resulting in either permanent or non-permanent nanostructure 110 aggregation. Maximum bending torque occurs when the meniscus 131 is at the top of the nanostructures 110 or at the beginning of the drying process. In nanostructures 110 composed of nanowires, the meniscus height is related to the nanowire radius with smaller nanowire radii exhibiting a higher degree of wetting. Thus, the aggregation force due to surface tension becomes greater for nanowires with a smaller diameter.

The electrode 102 and the counter electrode 104 are separated by a distance, D. In a material with relative permittivity, εᵣ, and an applied bias, V, between the electrode 102 and the counter electrode 104, a charge builds on the nanostructures 110. The charges on the nanostructures 110 provide an electrostatic repulsive force, Fₑₛᵣ, between adjacent structures (e.g., between nanostructures 110a and 110b). The force is dependent upon the spacing between the nanostructures 110. However, the tips come in closer proximity to each other as the nanostructures 110 deflect, thereby increasing the electrostatic repulsive force Fₑₛᵣ.

Aggregation is also partially mitigated by changes in liquid-air surface tension due to the electric field (i.e., the liquid-air surface tension changes as charge builds up on the nanostructure 110 surface). However, in most embodiments, the changes in the force due to surface tension, Fₛₜ, from the electric field is minor in comparison to the electrostatic repulsion force, Fₑₛᵣ.

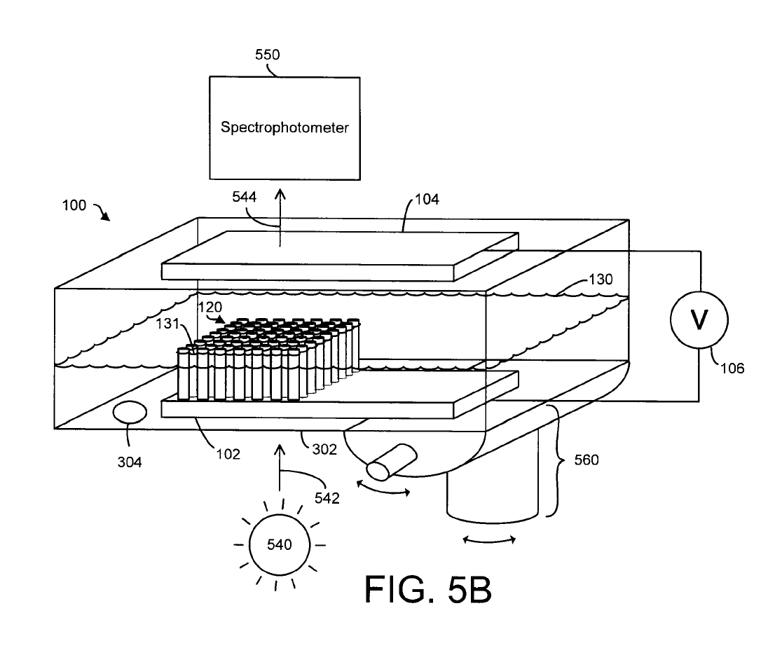

Referring now to FIG. 7, shown is a conceptual graph of nanostructure length versus the force acting on the nanostructures 110a and 110b illustrated in FIG. 6 for the case where the nanostructures 110a and 110b are nanowires. Therefore, a radius, R, of a nanowire is equal to the width, W, of a nanostructure 110 divided by 2. The dependence of length on the calculated forces involved in the two-body model is evident in FIG. 7. As seen in EQN (1), the force due to surface tension, Fₛₜ, is the only attractive force. For a given radius, R, this force is constant at any length, L. In the absence of an electric field, the only force countering Fₛₜ is the elastic bending force, Fₑₗₐₛ.

A critical nanostructure length, L_{c}, is the length at which the force due to surface tension, Fₛₜ, and the elastic bending force, Fₑₗₐₛ, balance. In other words, in FIG. 7, the critical nanostructure length, L_{c}, is the length at which the surface tension, Fₛₜ, curve and the elastic bending force, Fₑₗₐₛ, curve intersect. Nanowire lengths shorter than L_{c} have sufficient elastic energy to resist aggregation while those longer than L_{c} will aggregate to some degree.

The application of a small electric field, ξₒ, provides additional electrostatic repulsive forces, Fₑₛᵣ, resulting in a new critical nanostructure length L_{c}(ξₒ), as seen in FIG. 7. However, this small electric field has a minor influence on the aggregation behavior. Higher electric fields, ξ, provide substantial Fₑₛᵣ, raising the summed repulsive forces higher than Fₛₜ. At this field strength, nanowires of any length are forced apart, eliminating aggregation behavior due to surface tension. Although the small electric field alters Fₛₜ(ξ) according to the Lippmann Equation, the alteration is minimal (not shown). When substantially higher fields, of about 10 ξ, are applied, Fₛₜ changes considerably, as shown in FIG. 7.

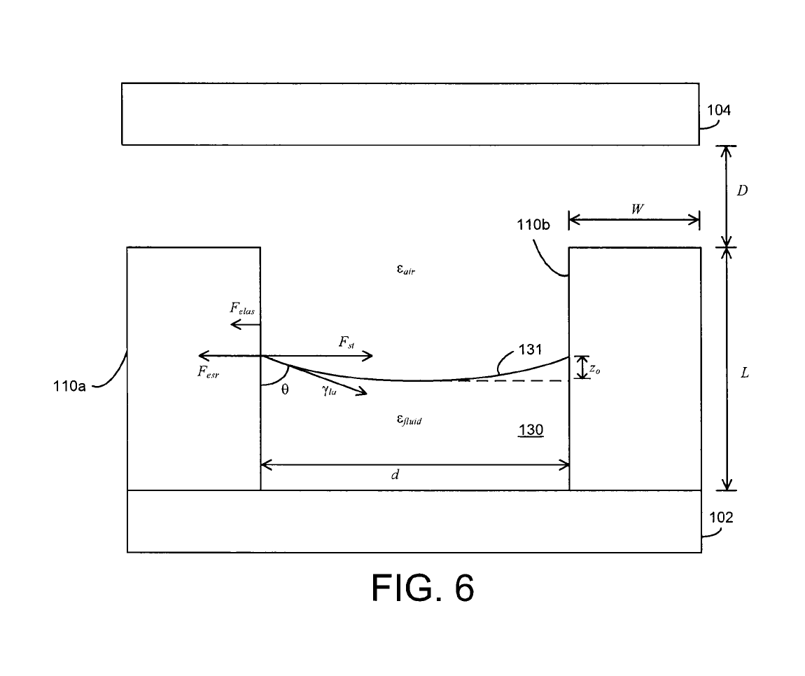

Turning now to FIG. 8, shown is a non-limiting embodiment of a method 800 of reducing an elasto-capillary coalescence of a plurality of nanostructures 110. FIGS. 1-6 will also be referenced in the following discussion of the method 800. The blocks discussed below may be performed in a different order from the one described, the blocks may be performed in parallel, and/or the blocks may be repeated in the method 800.

In block 805, an electrode 102 and a counter electrode 104 positioned opposite the electrode 102 are provided. In block 810, a plurality of wet nanostructures 110 are positioned on the electrode 102. The nanostructures 110 may be wetted with a fluid 130, such as water. The counter electrode 104 is positioned in air opposite the wet nanostructures 110. In block 815, an electric field is applied between the electrode 102 and the counter electrode 104 using a voltage source 106. This electric field reduces aggregation of the nanostructures 110. In some embodiments, the electric field may be applied again if subsequent processing is likely to increase the aggregation of the nanostructures. In that case, the electric field would be again applied to the nanostructures while they are wetted by a fluid.

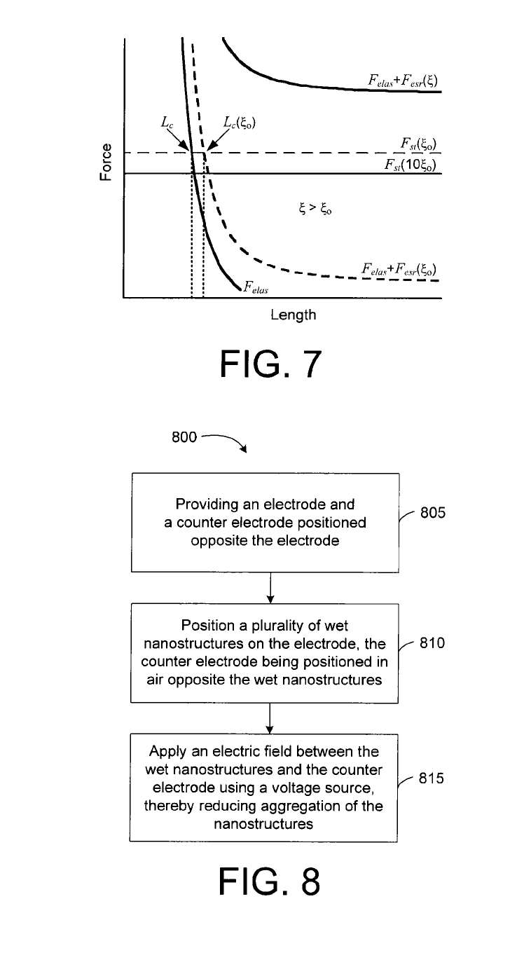

Turning next to FIG. 9, shown is a flow chart illustrating a non-limiting embodiment of a method 900 of creating a plurality of nanowires, which are an example of nanostructures 110, having reduced elasto-capillary coalescence. FIGS. 1-6 will also be referenced in the following discussion of the method 900. The blocks discussed below may be performed in a different order from the one described, the blocks may be performed in parallel, blocks may be omitted, and/or the blocks may be repeated in the method 900.

In block 905, a nanowire (or nanostructure) template is fabricated. In the example of FIG. 9, the template includes pores configured to receive a nanowire material and facilitate the growth of the nanowire. For example, in some embodiments, a porous anodic aluminum oxide (AAO) template is fabricated on a transparent conductive substrate. In other embodiments, the template is a polymer-based template, mesoporous silica, and/or mesoporous titania. The transparent conductive substrate may be composed of tin-doped indium oxide (ITO) on glass. In some embodiments, the ITO may have a film thickness of about 450±15 nm and a sheet resistance about 5 Ω/cm² or less. An interlayer is deposited, such as chromium or titanium (e.g., about 10 nm), followed by aluminum (e.g., about 2.2 μm) deposition at rates of about 0.1 m/s and about 20 nm/s using a custom electron-beam evaporation chamber operating at a pressure of about 5×10⁻⁶ torr. Following film deposition, aluminum anodization is carried out at a constant voltage by increasing the potential at a rate of about 100 V/min to a voltage set point that depends on the acid anodizing solution used and pore size desired. After anodization, the alumina barrier layer is etched with about 5 wt % phosphoric acid for about 330 seconds to expose the pore bottoms to the underlying ITO substrate. These pore bottoms form a template configured to receive a nanowire material and facilitate nanowire growth.

In block 910, a plurality of nanowires is formed. For example, the nanowires may be formed by electrochemically depositing a nanowire material, such as gold or other appropriate material, from a solution onto the exposed ITO layer within the pores of the AAO template. Referring to FIGS. 1-5, the solution is then held at about 60° C., and deposition is performed potentiostatically against a counter-electrode 104 at about −0.5 V versus an electrode 102. In some embodiments, the counter-electrode 104 may be a carbon counter-electrode and the electrode 102 may be a saturated calomel electrode. The deposition current may be monitored so that the nanowire material deposition is ceased once the current begins to rise dramatically, resulting in filled AAO template pores. In the case of gold nanowires, the resulting nanowires have a high surface energy and a low tensile strength.

In block 915, the nanowire template is removed from the nanowires. For example, in some embodiments, the formed nanowires are rinsed with de-ionized water and then placed in about 25 wt % phosphoric acid for about 1-2 hours to facilitate the selective removal of the alumina template from the nanowires. A freestanding array of vertical nanowires are then removed from the acid solution.

In block 920, the nanowires are rinsed using a fluid 130. For example, in some embodiments, the nanowires are rinsed by immersion in a fluid 130, such as deionized water and subsequently placed in fresh de-ionized water for storage. The nanowires may be stored in the fluid 130 to prevent nanowire aggregation.

Referring to FIGS. 1-6 and 9, in block 925, the electrode 102 is positioned opposite the counter electrode 104. In some embodiments, the nanowires may be fabricated on the electrode 102. In other embodiments, the nanowires may be positioned onto the electrode 102. In some embodiments, the electrode 102 is housed in a vessel 302 including a fluid 130, such as de-ionized water. An adhesive, such as double-sided tape, may be used to attach the electrode 102 to the nanowire repulsion device 302. In some embodiments, the nanowires are quickly positioned on the electrode 102 so as to reduce the time that the wet nanowires are exposed to air. Opposite of the nanowire array, a counter electrode 104 including a blank ITO substrate is positioned at variable working distances with a conductive side facing the nanowire surface.

In block 930, an electric field is applied between the nanowires and the counter electrode 104 using a voltage source 106. The electric field may be adjusted by varying either the applied voltage or working distance (D). In some embodiments, the applied voltage may range from about 0 to about 10 V. In some embodiments, the voltage is applied just after the nanowires are wetted or the fluid 130 was drained from the elasto-capillary coalescence reduction apparatus 100 (e.g., within about 5 seconds).

The voltage bias between the nanowires on the electrode 102 and counter-electrode 104 builds a capacitance layer on each nanowire, providing Coulombic repulsion while drying. The repulsion counteracts the surface tension forces, separating the nanowires and reducing elasto-capillary coalescence.

In block 935, the nanowires may be illuminated by a light source 540 (FIG. 5). Any deflections in the position of the nanowires will, therefore, influence light transmittance. In some embodiments, a position of a vessel 302 is adjusted to ensure that the light 542 (FIG. 5B) incident on the nanowires is parallel to an orientation of the nanowires in order to maximize the initial light transmittance (e.g., about 60% T).

In block 940, the degree of aggregation of the nanowires is detected. In some embodiments, the degree of aggregation is detected using spectral analysis. For example, in some embodiments, an elasto-capillary coalescence reduction apparatus 100, such as the one illustrated in FIG. 5 is used to perform spectral analysis while the nanowires dry. Since the vessel 302, electrode 102, and counter electrode 104 are transparent, real-time analysis of the aggregation behavior of the nanowires is possible. Spectral analysis can be performed at multiple wavelengths. In some embodiments, the spectral analysis is performed for a wavelength of about 550 nm. In other embodiments, the degree of nanowire aggregation may instead be determined by field emission scanning electron microscopy.

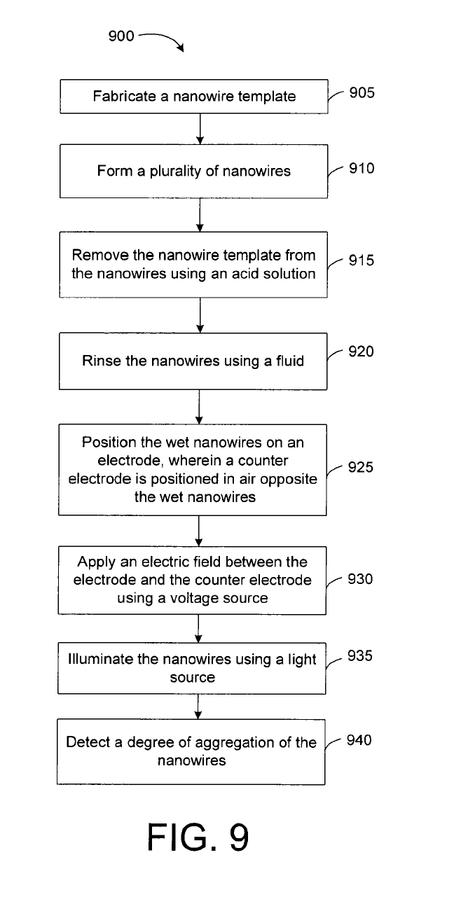

Turning now to FIG. 10, shown is a flow chart illustrating an embodiment of a method 1000 of measuring an elasto-capillary coalescence of a plurality of nanostructures 110. The nanostructures 110 may be wet or dry during the performance of method 1000. In block 1010, the nanostructures 110 are illuminated using a light source 540 (FIG. 5), similar to the illumination of block 935 of FIG. 9. At least some incident light 542 (FIG. 5B) is transmitted through the nanostructure array 120. In block 1015, a degree of aggregation of the nanostructures 110 is detected. The nanostructures 110 are positioned between the light source 540 and spectrophotometer 550 (FIG. 5), and the spectrophotometer 550 receives the light 544 (FIG. 5B) that is transmitted through the nanostructure array 120. Similar to the discussion above regarding block 940, the spectrophotometer 550 performs a spectral analysis on the received light 544 to determine the degree of aggregation.

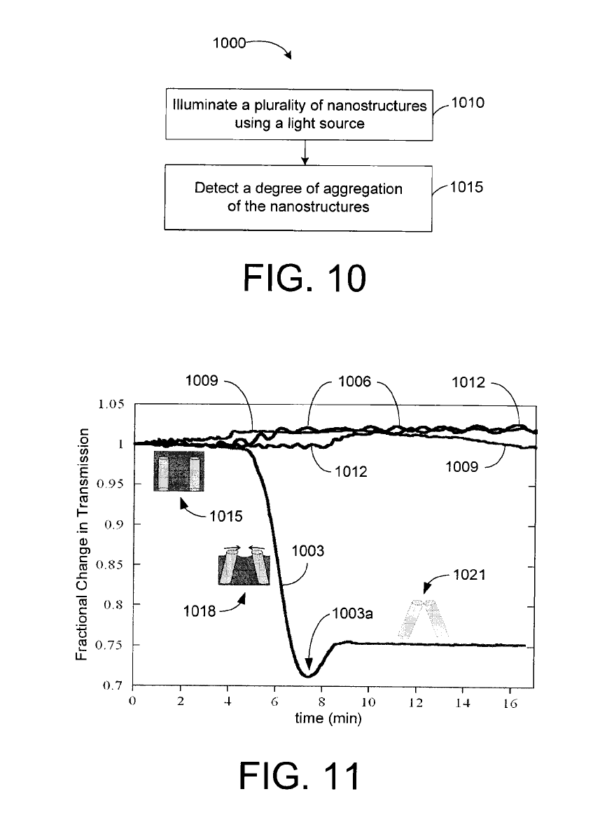

Referring next to FIG. 11, shown is a graph illustrating the fractional change in light transmission of nanostructures 110, which in this case are nanowires, under various applied electric fields versus time. Curves 1003, 1006, 1009, and 1012 are examples of a fractional change in transmission versus time while drying about a 2-3 μm long, gold nanowire array 120 using a working distance of about 1 mm and applied voltages of about 0 V, 0.1 V, 1 V, and 10 V, respectively.

Referring to curve 1003 of FIG. 11, once the fluid 130 is drained from the elasto-capillary coalescence reduction apparatus 100 and the fluid 130 on the array 120 dries, the nanowires begin to aggregate. The aggregation of the nanowires alters light transmission through the nanowire array 120. The nanowires are initially wetted 1015 and no change in transmission is observed as the fluid 130 begins to evaporate from the nanowires. The light transmittance then falls rapidly after about 5 minutes. In this region, the fluid 130 has evaporated to the point where the fluid 130 line is just below the top of the nanowires 1018 and the force due to surface tension is beginning to deflect the nanowires.

As the nanowires bend towards each other, less light can pass through the nanowire array. Therefore, a fractional change in transmitted light 544 is related to the nanowire aggregation density, while the slope of the transmittance curve 1003 is related to the rate of nanowire aggregation and the evaporation rate, which is a function of room temperature and humidity. The transmittance falls to a minimum value 1003a corresponding to the point of maximum nanowire aggregation. At this point, a small layer of fluid 130 likely coats each nanowire. As the fluid 130 evaporates, the transmittance slightly increases to a plateau region that remains significantly below the initial transmittance. This permanent drop in transmittance is due to irreversible nanowire aggregation. The nanowires that remain aggregated 1021 after this relaxation are either plastically deformed or the bending force is balanced by van der Waals forces or the surface energy of the nanowire material.

Referring to curves 1006, 1009, and 1012, FIG. 11 shows the transmittance while drying about a 2 μm long gold nanowire array using a working distance of 1 mm and applied voltages of about 0.1 V, about 1 V, and about 10 V, respectively, corresponding to electric field strengths of about 10² V/m, about 10³ V/m, and about 10⁴ V/m, respectively. It is apparent that this range of electric fields eliminates the reduction in transmission observed with no applied bias, maintaining nearly constant light transmission throughout the drying process.

Electric fields as low as about 10² V/m inhibit the aggregation of nanowires when dried in a fluid 130, such as water, providing an economical, generalized, and scalable approach to prevent the aggregation of nanowires on large-area substrates. The aggregation process can also be observed with optical transmission through the nanowire array using a spectrophotometer 550. These results show that aggregation significantly decreases light transmission through the array of nanowires. When electric fields are applied, only minor changes to the transmission are observed during the drying process, confirming that the nanowires remain separated while drying.

In some embodiments, ultrahigh-density arrays of nanostructures (e.g., nanowires) can be fabricated, for use in sensors, catalytic beds, and renewable energy devices, such as solar cells, thermoelectrics, batteries, and ultracapadtors. In these applications, available surface area can directly affect the performance of the device. Thus, the ability to reduce elasto-capillary coalescence of nanostructures increases the surface area, thereby providing significant benefits to these applications. For example, nanowire arrays have better charge transport that makes them advantageous for many energy storage and generation applications. However, the performance of nanowire arrays in solar cells typically falls short of expectations due to a lack of surface area. In many photovoltaic and charge storage applications, the surface area either defines the amount of electrons that are transferred or the amount of charge stored. An improvement in the density of nanowires and, consequently, the surface area of the nanowire array can result in improved conversion efficiency.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method of reducing an elasto-capillary coalescence of a plurality of nanostructures, the method comprising:
providing an electrode, a counter electrode, and a voltage source, wherein the electrode and the counter electrode are coupled to the voltage source;
providing a plurality of wet nanostructures on the electrode, wherein the counter electrode is positioned in air opposite the wet nanostructures;
applying an electric field between the counter electrode and the wet nanostructures using the voltage source, thereby reducing an aggregation of the nanostructures.

2. The method of claim 1, further comprising positioning the wet nanostructures on the electrode.

3. The method of claim 1, wherein the nanostructures are selected from the group consisting of: thin fin structures, micro-electro mechanical systems (MEMS,) nanopillars and nanowires.

4. The method of claim 1, wherein the nanostructures are compound nanostructures.

5. The method of claim 1, wherein the electrode is housed in a vessel.

6. The method of claim 1, wherein the nanostructures are wetted by a fluid, and wherein the fluid forms a meniscus between at least one of the nanostructures and a neighboring nanostructure.

7. A method of creating a plurality of nanowires having reduced elasto-capillary coalescence, the method comprising:
forming a plurality of nanowires;
positioning the nanowires on an electrode, wherein a counter electrode is positioned in air opposite the nanowires, wherein the nanowires are wetted by a fluid; and
applying an electric field between the electrode and the counter electrode using a voltage source.

8. The method of claim 7, further comprising:
illuminating the nanowires using a light source; and
detecting a degree of elasto-capillary coalescence of the nanowires.

9. The method of claim 8, wherein detecting a degree of elasto-capillary coalescence further comprises performing spectral analysis on light transmitted through the nanowires using a spectrophotometer.

10. The method of claim 7, further comprising:
fabricating a nanowire template, wherein the nanowires are formed using the nanowire template.

11. The method of claim 10, further comprising:
removing the nanowire template from the nanowires using an acid solution; and
rinsing the acid solution from the nanowires using the fluid, the rinsing resulting in wet nanowires.

12. A method of measuring the elasto-capillary coalescence of a plurality of nanowires, the method comprising:
illuminating a plurality of nanostructures using a light source; and
detecting a degree of aggregation using a spectrophotometer.

13. The method of claim 12, wherein the nanostructures are wetted by a fluid.

14. An elasto-capillary coalescence reduction apparatus comprising:
an electrode configured to receive a plurality of wet nanostructures;
a counter electrode positioned in air opposite the wet nanostructures; and
a voltage source coupled to the electrode and the counter electrode, the voltage source being configured to apply an electric field across the electrode and the nanostructures, wherein the application of the electric field causes each of the nanostructures to repel a neighboring nanostructure.

15. The elasto-capillary coalescence reduction apparatus of claim 14, wherein the counter electrode and nanostructures are housed in a vessel configured to contain a fluid.

16. The elasto-capillary coalescence reduction apparatus of claim 14, wherein the vessel includes a drain hole.

17. The elasto-capillary coalescence reduction apparatus of claim 14, wherein the electrode, counter electrode, and vessel are transparent.

18. The elasto-capillary coalescence reduction apparatus of claim 14, further comprising a spectrophotometer configured to perform spectral analysis on light transmitted through the nanostructures.

19. The elasto-capillary coalescence reduction apparatus of claim 14, wherein the spectral analysis indicates a degree of elasto-capillary coalescence of the nanostructures.
